(19) United States
(12) Patent Application Publication
(10) Pub. No.: US 2016/0241898 A1
(43) Pub. Date: Aug. 18, 2016

(54) METHOD FOR PLAYING BACK AND SEPARATELY STORING AUDIO AND VIDEO TRACKS IN THE INTERNET

(71) Applicant: Bernd KORZ, Obrigheim (DE)

(72) Inventor: Bernd Korz, Obrigheim (DE)

(21) Appl. No.: 15/026,879

(22) PCT Filed: Oct. 9, 2014
(86) PCT No.: PCT/DE2014/000498

§ 371 Date: Apr. 1, 2016

(30) Foreign Application Priority Data
Oct. 10, 2013 (DE) 10 2013 017 031.1

(51) Int. Cl. H04N 21/2743; H04N 21/61; H04N 21/658; H04N 21/81; H04L 29/06; H04N 21/239

(52) U.S. Cl. CPC H04N 21/2743; H04L 65/4069; H04N 21/2393; H04N 21/658; H04N 21/8106; H04N 21/6125; H04N 21/6175

(57) ABSTRACT

In the method an indefinite number of audio tracks are stored separately for each video film, in order to be played back in sync with the video in the Internet. Hence, a video can be stored in any number of languages, and at any time the language can be changed in real time during the playback of the video without having to reload the video. This method works well for different sources, for example, different video platforms, on which the same video is offered, because the platforms all use the same stored audio tracks. This feature and the small size of the audio tracks reduce the upload and memory requirement by about 90%, as compared to the conventional method of having to provide in each case a single video, including the audio/language track, for each individual language.

This application is a national stage application, filed under 35 U.S.C. §371, of International Application No. PCT/DE2014/000498, filed Oct. 9, 2014, which claims priority to German Application No. 10 2013 017 031.1, filed Oct. 10, 2013, the contents of both of which as are hereby incorporated by reference in their entirety.

In order to be able to offer a video film (hereinafter also referred to as video) in a number of languages online through, for example, a video portal, the video film has to be uploaded to a video portal or a website in a specific language and offered by the respective service. In order to be able to offer the same video in another language, the same video has to be uploaded again to this video portal or a website with a different sound track. This procedure has to be repeated then for each additional language. If a video has a file size of a total of 500 megabytes (MB), and if a video were offered in 5 languages, then no less than a total of 5×500 MB of data, i.e., about 2.5 gigabytes (GB) for each video resolution that, for example, a video platform offers, would have to be stored on a data carrier. In general, video providers have a wide range of video resolutions of, for example, 240p, 360p, 480p, 720p and 1080p. Consequently these 2.5 GB would have to be stored now once again for each additional resolution, i.e., 5×2.5 GB. In this case the total amount of memory required on storage media would exceed 10 GB.

In terms of the amount of data to be transferred, it would be such that 2.5 GB of data would have to be transferred.

At the present time it is also possible to play an audio track, as an alternative language, with a time delay of 0.5 seconds to 2.0 seconds. In this case an audio track is simply loaded onto an existing track; and the original audio track is not completely suppressed; this method only applies to one language and not in the online domain. For this approach there is a patent application with the number U.S. Pat. No. 5,189,562 A, filed on Jun. 25, 1990.

The object of the present invention is to make the actual video and the accompanying audio track for each language available individually in the Internet and then to play it back in sync with the video.

The object is achieved in that the provider of the video uploads the entire video with or without a language track to the Internet only once; this can also be done by an external provider (hereinafter referred to as the client). In this case there are no changes in the already existing method of making the video available on, for example, a video platform in the Internet. Then the provider uploads a language track for each of the languages, which are to be made available by the provider, to the same server or an external server. On the browser side, the video and the selected language track will now be played in sync with each other in the Internet. While the video is playing, the available language tracks can be selected and changed any number of times. At each change the method recognizes the exact point in the video and plays it back in sync.

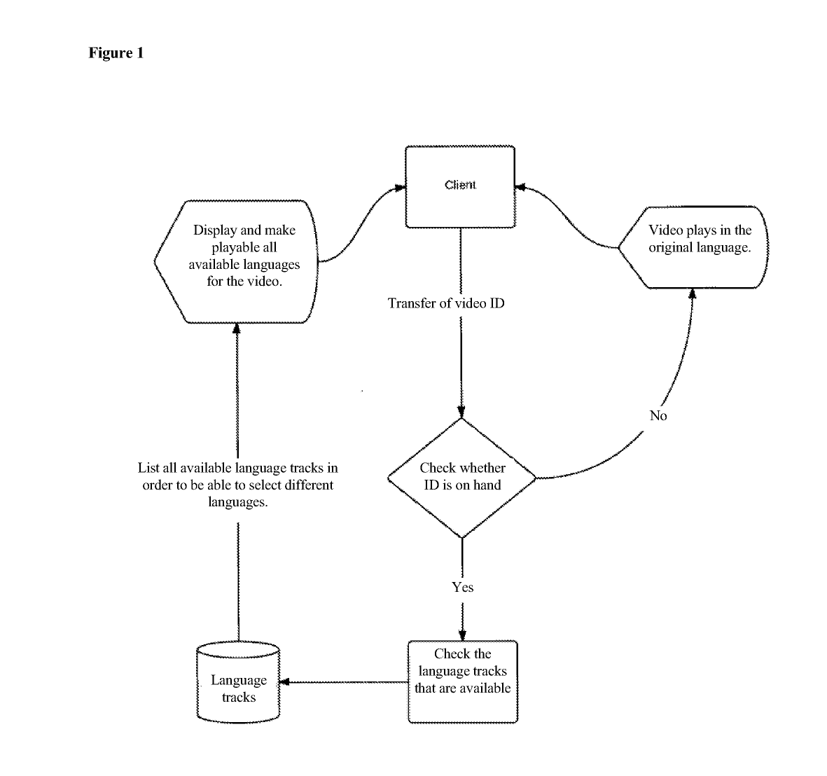

For this purpose the method is installed on the device of the user as, for example, a browser extension (extension) or as an application. Similarly the method can be integrated directly in a web page or a video portal. Then this extension checks (FIG. 1) the video ID (unique identification number) or URL (Internet address of a video) that the provider is sending for the video requested. Then this ID is stored in a database, where the language tracks that are available are checked and then displayed in a freely definable location directly in the video or in an external window. At this point the viewer can simply click the language, in which he wants to see the video, and the respective language is loaded. The method described herein allows videos to be stored and played back with language tracks in all known languages and dialects.

A video film can still be released, now as before, with the original sound track in the Internet (for example, by uploading through a video platform). The audio tracks, which exist for the respective language, will now be stored separately on the same server or an external server. Now a time stamp, which is stored by the provider in the video, will be loaded synchronously with the time stamp of the respective audio file for a language and will be adapted to each other. At this point the viewer can constantly switch to a different language at any point in the video or just once at the start of the video without having to reload the video.

As a result, the video has to be uploaded in full file size only once by the client. The vastly smaller audio files can be stored on an external server as well as on the same server of the video.

By using the method described herein the client and the video supplier save up to about 90% of the uploaded volume of data, because the supplier only has to upload a single video file in the original language and the corresponding other language tracks. If the supplier uploads, for example, a video that has in English a size of about 500 MB, the language track is no more than about 5 MB (about 1/100 of the total file size). If at this point the video supplier wants to offer 10 languages in the conventional way, said supplier would have to upload 10×500 MB, i.e., about 5 GB. By applying the method described herein, said video supplier would only have to upload 1×500 MB (for the video) and 10×5 MB (for each language track), i.e., 550 MB, as the total size of the data files. This method dramatically reduces the traffic (the transfer volume due to the transfer of data in a computer network or, more specifically, the Internet) as well as the necessary memory at the provider.

For the sake of a better understanding the method is explained by means of the following example, with a one minute video with five languages:

Sequence in a video upload by the provider:

1. The video is uploaded to a video platform at the highest resolution (full HD/1080p) that can be achieved at the present time.

2. Then the provider makes this video available in 240p, 360p, 480p, 720p, 1080p (the mobile versions of the videos have not been considered yet!).

3. The viewer can now view the video at these resolutions.

Therefore, if it is assumed that a video is 60 seconds long, the following file sizes for each language will apply:
1080p—27.61 MB
720p—12.68 MB
480p—5.71 MB
360p—4.41 MB
240p—2.78 MB
TOTAL 52.19 MB

The total amount of memory for a video in one language is now 53.19 MB. In the example, five languages are provided. Therefore, for these five languages the video would have a size of 260.95 MB (52.19 MB×5 for each language) at the provider's site. This is the amount of memory that the provider has to make available for each minute of video.

What happens now with this method? The video will be uploaded with a language, i.e., the 52.19 MB, by the provider; and for each additional language only the language track, which is about 1 MB per minute, has to be uploaded separately. As a result, instead of 260.95 MB, only a volume of 52.19+5×1 MB, i.e., only a volume of 57.19 MB of data, is necessary for the upload and the storage.

1-4. (canceled)

5. Method for playing back and storing video films in the Internet in a number of languages, said method comprising the steps of the audio and video files being stored separately, wherein for each video film there can be only one video track and an indefinite number of audio tracks for different languages, which refer to the video track and, thus, making it possible to play back the video with the languages that the video author provides as the language tracks, in order to reduce the memory requirements to a minimum of the normal memory and data transfer requirement for uploading and storing.

6. Method, as claimed in claim 5, wherein the uploaded amount of data is reduced by up to 90% and, as a result, the traffic (transfer volume due to the transfer of data in a computer network or, more specifically, the Internet) as well as the necessary memory for storing the video and audio files are significantly reduced at the provider.

7. Method, as claimed in claim 5, wherein the video is uploaded only once, and only the respective sound tracks in the stored languages are uploaded separately.

8. Method, as claimed in claim 5, wherein the actual video and the accompanying sound track for each language are made individually available in the Internet and then played back in sync with the video.
